(19) United States
(12) Patent Application Publication
(10) Pub. No.: US 2002/0021777 A1
(43) Pub. Date: Feb. 21, 2002

(54) Method and apparatus to monitor loading using vibration

(76) Inventor: Mitchell R. Swartz, Weston, MA (US)

Correspondence Address: Mitchell R. Swartz, ScD, EE, MD, 16 Pembroke Road, Weston, MA, 02493, US

(21) Appl. No.: 09/750,480

(22) Filed: Dec. 28, 2000

Related U.S. Application Data
(63) Continuation of application No. 07/371,937, filed on Jun. 27, 1989.

(51) Int. Cl. G21J 1/00; G21B 1/00

(52) U.S. Cl. 376/100

(57) ABSTRACT

The present invention relates to processes and systems involving loading, such as palladium internally filling [“loading”] with deuterons. The system includes a novel cathode able to vibrate at a natural frequency, means to drive said frequency, and means to monitor said frequency, means to relate frequency changes to changes in the cathodic mass which herald loading. In one configuration said means to vibrate said cathode occurs by an applied external magnetic field intensity.

This is a continuation of U.S. Ser. No. 07/371,937 Filed: Jun. 2, 1989

The present invention relates to processes and systems involving loading, such as palladium internally filling [“loading”] with deuterons, but it has relevance as well, to deuteron storage devices using deuterium (an isotope of hydrogen), to fuel cells, to nuclear fusion, to metallurgy, and to systems using loading. The method to monitor loading using a vibration includes a novel cathode able to vibrate at a natural frequency, means to drive said frequency, and means to monitor said frequency, means to relate frequency changes to changes in the cathodic mass which herald loading.

In one configuration said means to vibrate said cathode occurs by an applied external magnetic field intensity.

By way of background and to place reasonable limits on the size of this disclosure, the following publications are noted:

CRC Handbook of Chemistry and Physics, published by Chemical Rubber Co., Weast, R.C., et alia, 1973), pp C718-719, pp D152;

Hampel, C.A., Editor, Rare Metals Handbook, published by Reinhold Publishing Corp, (1954), pp 312, 319, 322-325;

Morrish, A.H., The Physical Principles of Magnetism, John Wiley & Sons, Inc. NY (1966), pp. 69, pp 228-229;

Swartz, M. R.. Application Serial number: 07/339,976, Filing Date: Apr. 18, 1989

Uhlig, H. H., Corrosion and Corrosion Control, published by John Wiley & Sons, Inc., (1971), pp 142-143.

The present invention relates to electrochemical reactions in or about metals, such as palladium which has been electrochemically loaded with deuterium, but it has relevance as well, to hydrogen storage devices, fuel cells, nuclear fusion, metallurgy, and other reactions in pressure-loaded metals such as titanium or palladium filled with deuterium, and to the broader field of metallurgy and engineering in or about metals, including Groups IVb, Vb, and some rare earths.

Deuteron (an isotope of hydrogen) storage devices, fuel cells, and other systems offer the opportunity of improved energy utilization.

It is well known that deuterons are soluble in palladium and other metals. Unlike the other metals, palladium has a deuteron solubility that falls rapidly as the temperature rises, while the rate of diffusion increases (Hampel).

However, the process is complicated.

It must be followed to maximize the likelihood of the desired reactions.

Present methods to monitor the changes of deuterium loading into palladium (and other metals) are made difficult in that the material must be removed from the reaction chamber, thereby not only stopping the reaction, but also cross-contaminating both the cathode and the laboratory.

The rate of the desired reactions is very low.

Accordingly, it is a principal object of the present invention to provide a novel method and system to monitor loading. Specifically, the loading is monitored in situ. The system includes a novel cathode able to vibrate at a natural frequency, means to drive said frequency, land means to monitor said frequency, means to relate frequency changes to changes in the cathodic mass which heralds loading. In one configuration said means to vibrate said cathode occurs by an applied external magnetic field intensity. Said magnetic field intensity is also used to concentrate deuterons within said cathode.

The foregoing objects are achieved, generally, in a method (and system) to monitor loading. The system includes

a novel cathode able to vibrate at a resonant frequency

and means to monitor said frequency

and means to relate said information so as to monitor those changes in cathodic mass which herald loading,

means to couple said cathode with an irradiation source;

and means to monitor said frequency, so as to monitor said reactions while driving the galvanostatic deposition of deuterons.

a control device which drives, monitors, and collects data during said reactions;

The invention is hereafter described with reference to the accompanying drawings in which:

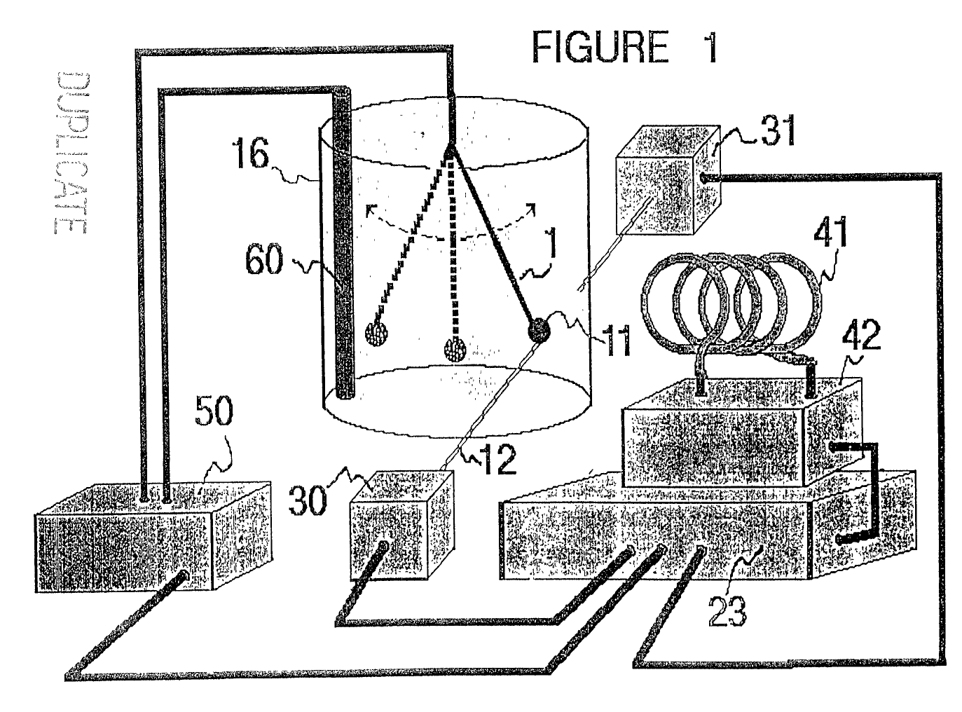

FIG. 1 is a simplified three-dimensional diagram of the reaction vessel and monitoring system.

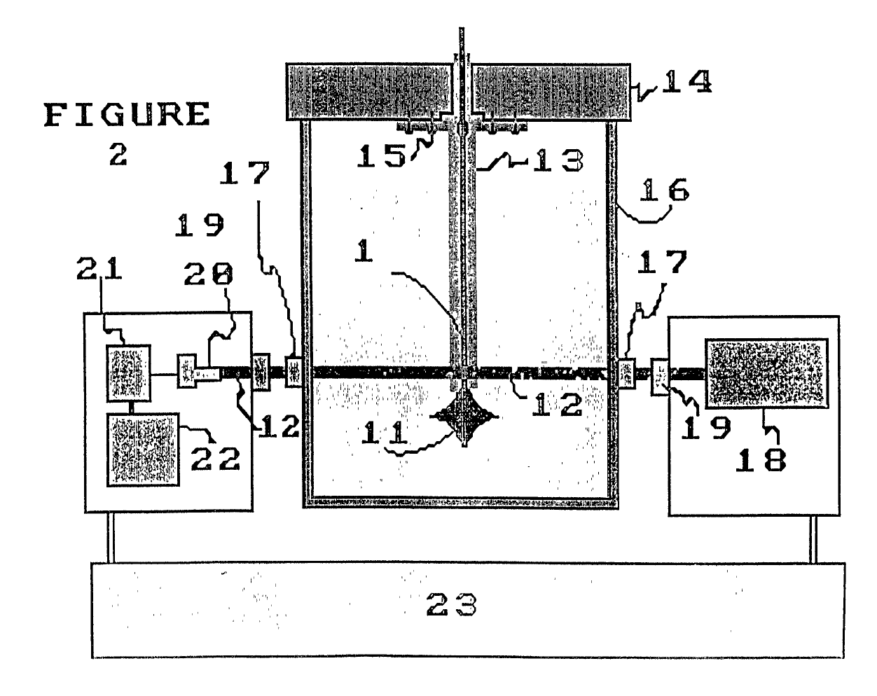

FIG. 2 shows a vertical cross-sectional slice of the reaction cell with the optical monitoring system.

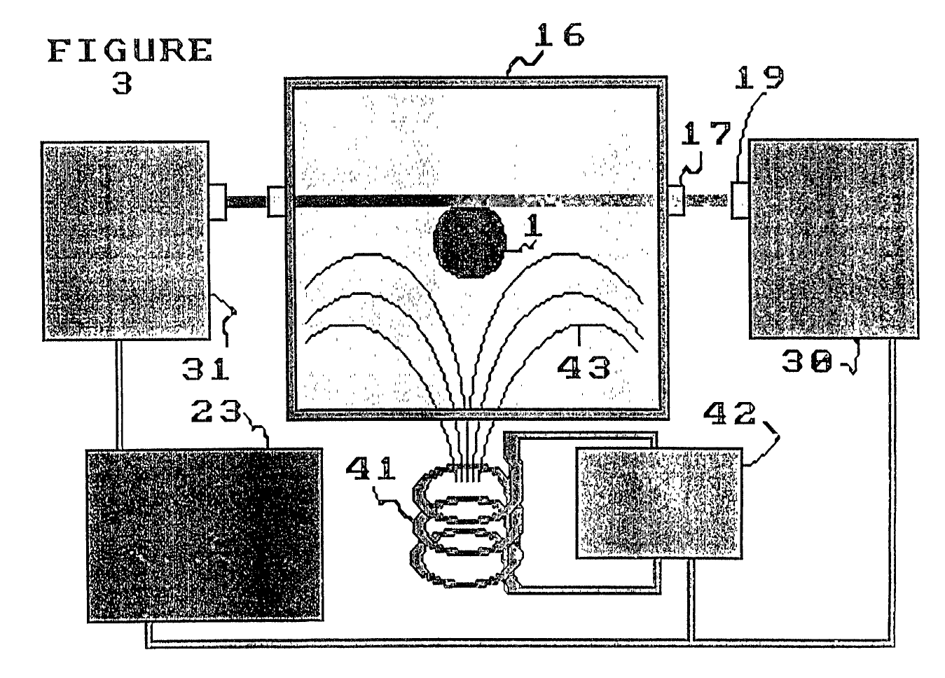

FIG. 3 shows the horizontal cross-sectional slice of the reaction cell showing the optical monitoring system and the orthogonal magnetic pumping coil.

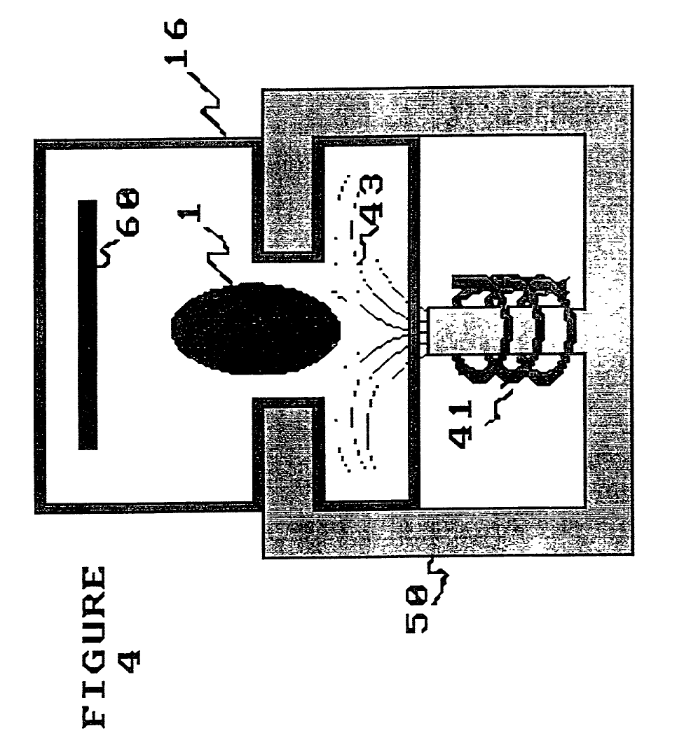

FIG. 4. shows the horizontal cross-sectional slice of the reaction cell showing the magnetic pumping system including coil and high permeability core.

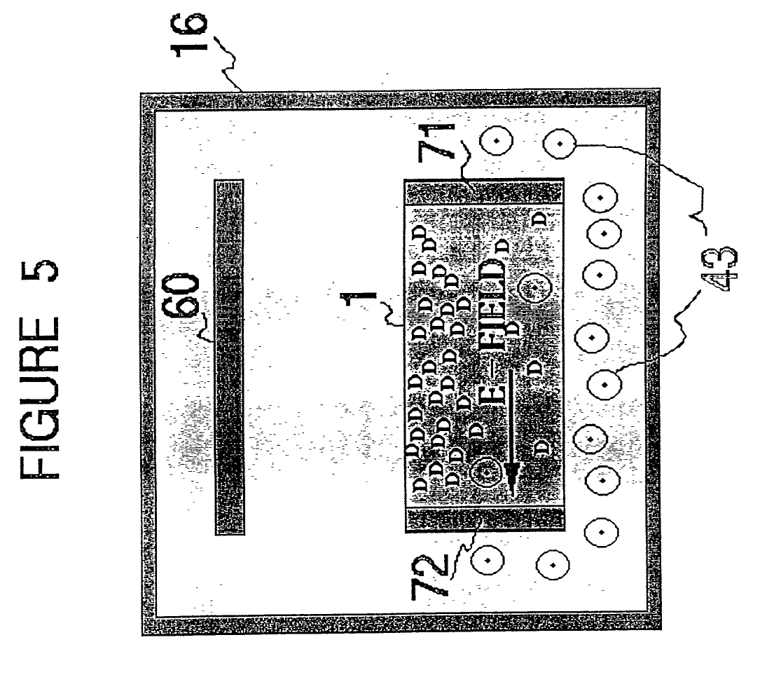

FIG. 5. shows a horizontal cross-sectional slice of a reaction cell containing a modified cathode capable of supporting an internal current.

Turning now to the figures, FIG. 1 is a simplified three-dimensional diagram of the reaction monitoring system, showing an electrochemically loading system (“reaction system”) containing the vibrating cathode, and accompanied by the optical monitoring system and the orthogonal magnetic pumping coil.

Within the reaction chamber (labeled as number 16) is the platinum anode (labeled a number 60), and the palladium cathode (labeled as number 1). These electrodes are driven by an external electrical power system (labeled as number 50).

The cathode (labeled as number 1) has a variety of positions of which three are shown. These displacements are greatly magnified in FIG. 1. For simplicity the reactor (16) is filled to the top. Not shown are the mechanical system which enables said cathode to vibrate between said displacements, or the cover of the reactor.

When this novel cathode does move, it interferes with an optical beam (labeled as number 12 in FIG. 1).

The optical beam originates from an optical laser contained in an optical irradiator subsystem (labeled as number 30) and is detected electrooptically by an optical detection subsystem (labeled as number 31). The photodetector and associated equipment are not shown in this figure.

The repetitive cutoff of the optical beam occurs due to the physical displacement of the cathode during an oscillation as described herein. These oscillations may occur during the loading of said cathode, or may occur periodically. The mass of the cathode (increasing by adsorption of deuterons) increases antecedent to the desired reactions, and results in a decreasing of the frequency of said oscillation (vide infra). The mass is derived from the decrease in oscillation frequency.

The frequency information is collected, and all the subunits are driven, by a central control unit. (labeled as number 23). Said control unit also powers the means to drive said vibrational frequency, consisting of a power source (labeled as number 42) and a coil (labeled as number 41, of which only a few turns are shown in FIG. 1).

Turning now to FIG. 2 shows a vertical two-dimensional cross-sectional slice of the reaction cell with the optical monitoring system, located on the extreme right and left of said figure. The cathode is shown centrally as a vertical rod (labeled as number 1), connected to a lower large mass (labeled as number 1 1). For example, in this case a spiked cathode is shown. However, the actual configuration might be a distributed mass.

The optical beam (labeled as number 12) is shown passing directly in front of the cathode. Part of the cathode is hidden in the figure due to the beam. The optical beam is provided by a laser (labeled as number 18), and is directed by appropriate optical lenses and/or beam splitters (labeled as number 19) located in the optical subsystems. Said beam is detected by the detector subsystem, containing the optical detectors (e.g. a phototransistor (labeled as number 20), an event detector (e.g. Schmidt trigger) to detect transitions (labeled as number 21) and a frequency counter (labeled as number 22). The optical subsystems are controlled by the control unit (labeled as number 23).

FIG. 2 shows that the cathode may be covered over a fraction of its surface by another “springy” material so as to alter the resonant frequency of the vibrating cathode. Said material is labeled as number 13. Said material thereby forms a single composite mass with either the cathode (e.g. palladium) or a wire leading to said cathode (e.g. platinum). Said composite mass provides the additional possibility of forming a structural bonding to, and an electrical insulation from, a large mass (labeled as number 14), located outside of the reaction cell. Said reinforcing material (13) may even be bolted (labeled as number 15) to said large external mass (labeled as number 14).

Some reactors may not be “in jars” and may be quite shielded. Therefore provisions can be made for transparent windows (labeled as number 17) on said reactors. This would be done to permit monitoring of said vibrational cathode.

The cathode can be modeled as a pendulum, and any analysis is simplified by considering that most of the mass resides in the large terminal portion of said cathode (labeled as number 11).

The analysis can be derived from Newton's Law, from the viscous damping force, and the approximation that the cathode behaves similar to a basic mass/spring-type system.

The equation of motion is

$$m \frac{{d}_{x}^{2}}{dt} = - [ k \cdot x ] - [ A \cdot b \cdot \frac{ⅆ x}{ⅆ t} ]$$

where k is the first order spring constant characterizing the cathode, and b is the parameter relating frictional force exerted by the solution upon the cathode to the velocity of said cathode. By Stokes' law, the parameter “b” is closely related both to the viscosity of the solution in the reactor and the size of the cathode perpendicular to the velocity of said cathode (“A”).

The solution to the equation of motion is that of a damped sinusoid, with a natural angular frequency of a damped oscillator.

$$ω = {ω}_{o} - [ \frac{{b}^{2}}{4 {m}^{2}} ] = [ \frac{k}{m} ] - [ \frac{{b}^{2}}{4 {m}^{2}} ]$$

A ‘Quality factor’, Q, can be derived as

$$\frac{ω \cdot m}{b}$$

where the expected natural frequency is:

$${ω}^{2} = {ω}_{o}^{2} \cdot ( 1 - \frac{1}{4 \cdot {Q}^{2}} )$$

The next table (Table 1) relates the above equations and shows that the natural frequency of said cathode is dependent upon the viscous factor, it is only significantly altered at very high viscosity (where the Quality factor approaches zero). In the air, b would be very small, but under the conditions of the desired reactions, it is not zero within the heavy water solution. However, said viscosity is small to begin with, and the variation of viscosity with temperature shows a decrease with increasing temperature rise. The result is that the viscous damping further decreases as the loading process proceeds.

TABLE 1
QUALITY FACTORS OF VIBRATING CATHODE

| K | VISCOSITY | MASS | ω₀ | QUALITY | ω |
|---|---|---|---|---|---|
| 10,000,000 | 1 | 10 | 1000 | 10000 | 1000 |
| 10,000,000 | 2 | 10 | 1000 | 5000 | 1000 |
| 10,000,000 | 4 | 10 | 1000 | 2500 | 1000 |
| 10,000,000 | 8 | 10 | 1000 | 1250 | 1000 |
| 10,000,000 | 16 | 10 | 1000 | 625 | 1000 |
| 10,000,000 | 64 | 10 | 1000 | 156 | 1000 |
| 10,000,000 | 128 | 10 | 1000 | 78 | 1000 |
| 10,000,000 | 256 | 10 | 1000 | 39 | 1000 |
| 10,000,000 | 512 | 10 | 1000 | 20 | 1000 |
| 10,000,000 | 1024 | 10 | 1000 | 10 | 999 |
| 10,000,000 | 2048 | 10 | 1000 | 5 | 995 |
| 10,000,000 | 4096 | 10 | 1000 | 2 | 979 |
| 10,000,000 | 8192 | 10 | 1000 | 1 | 912 |
| 10,000,000 | 16384 | 10 | 1000 | 0. | 574 |

In summary, the result is that Table 2 suggests that the expected frequency change associated with full loading is approximately 6 to 1 0% of the initial frequency.

Because the natural frequency can be counted with a laser beam and photodetector (coupled to a trigger and frequency counter), an accurate in situ determination of frequency is possible.

TABLE 2
DERIVED VIBRATION FREQUENCIES
OF VIBRATING CATHODE
(Normalized to both the initial frequency and mass
of said cathode, before loading with deuterons)

| mass | freq. | mass | freq. | mass | freq. |
|---|---|---|---|---|---|
| 100 | 100.00 | | | | |
| 101 | 99.50 | 111 | 94.92 | 121 | 90.91 |
| 102 | 99.01 | 112 | 94.49 | 122 | 90.54 |
| 103 | 98.53 | 113 | 94.07 | 123 | 90.17 |
| 104 | 98.06 | 114 | 93.66 | 124 | 89.80 |
| 105 | 97.59 | 115 | 93.25 | 125 | 89.44 |
| 106 | 97.13 | 116 | 92.85 | 126 | 89.09 |
| 107 | 96.67 | 117 | 92.45 | 127 | 88.74 |
| 108 | 96.23 | 118 | 92.06 | 128 | 88.39 |
| 109 | 95.78 | 119 | 91.67 | 129 | 88.05 |
| 110 | 95.35 | 120 | 91.29 | 130 | 87.71 |

Turning now to FIG. 3, shown is the horizontal two-dimensional slice through the reaction cell showing the optical monitoring system and the orthogonal magnetic pumping coil. The view is through the top of the reactor (labeled as number 16). The vertical cathode appear as a round central dot (labeled as number 1). For simplicity, the anode, the electrical interconnections, and electric drive system are not shown.

The optical irradiator subsystem and optical detection subsystem are labeled as numbers 30 and 31. In the configuration shown in FIG. 3, said cathode (labeled as number 1) is electromagnetically driven by the transverse magnetic coil (labeled as number 41). For the monitoring configuration, said cathode is driven periodically by the driving subsystem (labeled as number 42) to produce a magnetic field intensity (with flux lines labeled as number 43) located in the vicinity of said cathode (1).

The magnetic field is stored energy. The total energy of the whole system (magnetic field, reactor, vibrating cathode, etc.) is minimized by motion of said cathode. Hence the vibrations are created. Mathematically, the magnetic force is obtained from taking the derivative of the magnetic energy as a function of the cathodes displacement.

Turning to FIG. 4, a highly (magnetically) permeable material (labeled as number 50) can be mounted as a core in said external coil (labeled as number 41), with a continuation of said high ly permeable material circumferentially around the reactor. In FIG. 4 the reactor (labeled as number 16) is shown modified so as to minimize the distance between said cathode (labeled as number 1) and said highly permeable material (labeled as number 50).

The magnetic susceptibility of palladium and deuteron-filled palladium (or other metal) is what creates the energy transfer to the vibrational frequency of the cathode. Table 3 presents the relevant susceptibilities.

TABLE 1
Magnetic Susceptibility (*10⁻⁶ cgs)
[adapted from CRC Handbook of Chemistry and Physics]

| material | temp. (deg. K) | suscept. |
|---|---|---|
| H₂O | 373 | −13.09 |
| H₂O | 293 | −12.97 |
| H₂O | 273 | −12.93 |
| HDO | 302 | −12.97 |
| D₂O | 277 | −12.76 |
| D₂O | 288 | −12.66 |
| Pd | 291.3 | 567 |
| PdCl₂ | | −38 |
| PDF3 | | 1,760 |
| PdH | | 1,077 |
| Pd₄H | | 2,353 |

Another monitoring configuration involves using said external magnetic field intensity to align the magnetic moments of the deuterons within said cathode. The application of a suitable radio-frequency power source and the ability to measure the power absorption also enables the cathode to have its intravolumetric deuteron population measured in situ.

Yet another monitoring configuration involves the use of a second external mass coupled to the above cited large external mass. Forced mechanical vibration of said second external mass will eventually couple phonons to the cathode and thereby cause it to vibrate at its own natural frequency. The monitoring system would be similar to that described above.

Furthermore, other benefits arise from the arrangements shown of an applied external magnetic field. In addition to inducing a vibrational frequency of the cathode, the magnetic field intensity can be used to collect the deuterium within a portion of said cathode.

Turning now to FIG. 5, shown is the reactor (16), the anode (60), and modified cathode (labeled as number 1). For simplicity the optical and magnetic subsystems are not shown. The deuterons are shown in solution and within said cathode. The deuterons are labeled by the letter “D”. Said modified cathode is capable of supported an internal transcathodic current. There are two sites on said cathode where platinum wires are attached (labeled as number 71 and 72). The locations are the sites to which are applied an additional potential gradient so as to produce an electrical field within said cathode.

The purpose of the applied internal electrical field intensity is to produce a velocity to the deuterons (or other charge carriers) located within said cathode. In the presence of the above cited magnetic field (which is labeled as number 43 in FIG. 5 and is perpendicular to, and out of, the paper), with the application of said orthogonal electric field and the resultant velocity of particles within said cathode, there is produced a Lorentz force upon said charge carriers. Said force produces a clustering and compaction of said deuterons as is shown in FIG. 5.

The present invention relates to processes and systems involving loading, such as palladium internally filling [“loading”] with deuterons, but it has relevance as well, to deuteron storage devices using deuterium (an isotope of hydrogen), to fuel cells, to nuclear fusion, to metallurgy, and to systems using electrolytically loaded and pressure-loaded metals.

A method to monitor loading using a vibration includes a novel cathode able to vibrate. The method and apparatus includes means to drive said frequency, and means to monitor said frequency, means to relate frequency changes to changes in the cathodic mass which herald loading. In one configuration said means to vibrate said cathode occurs by an applied external magnetic field intensity.

Modification of the invention herein disclosed will occur to persons skilled in the art and all such modifications are deemed to be within the scope of the invention as defined by the appended claims.

What is claimed is:

44. In a process for producing a product using a material which is electrochemically loaded with second material, a method of monitoring the loading within said material that comprises:
loading said second material,
mechanically coupling said material so as to enable a mechanical vibration of said material,
providing means to drive said vibration, and
providing means to follow the frequency of said vibration.

45. A process as in claim 44 wherein the frequency of said vibration is followed by the material producing interference with an optical beam.

46. A process as in claim 44 wherein said material is a member of the group consisting of palladium and palladium alloys.

47. A process as in claim 44 wherein said second material is a member of the group consisting of deuterium or deuterons.

48. A process as in claim 44 wherein said means to provide drive of said vibration comprises coupling said material to a second mass located external to said material.

49. A process as in claim 48 wherein said second mass is an electromechanical device capable of a vibration.

50. A process as in claim 44, where the material is loaded as an electrochemical cathode.

51. In a process for loading a material with a second material, a method of monitoring the loading within said material that comprises:
loading said second material,
mechanically coupling said material so as to enable a mechanical vibrations of said material,
providing means to produce said vibrations,
providing means to detect the frequency of said vibrations.

52. A process as in claim 51, where the material is loaded electrochemically.

53 A process as in claim 51 wherein the frequency of said vibration is followed by the material producing interference with an optical beam.

54. A process as in claim 51 wherein said material is a member of the group consisting of palladium and palladium alloys.

55. A process as in claim 51 wherein said second material is a member of the group consisting of deuterium or deuterons.

56. A process as in claim 51 wherein said means to drive said vibration is provided by additional coupling also to a longitudinal mass capable of providing restoring force along its length,

57. A process as in claim 51 wherein said means to drive said vibration comprises coupling said material to a second mass located external to said material.

58. A process as in claim 57 wherein said second mass is capable of having at least one vibrational frequency.

59. A process as in claim 57 wherein said second mass is driven by an electromechanical device.

60. An apparatus to monitor the loading of a material by a second material which includes in combination:
means to load said second material,
means to enable mechanical vibrations of said material by mechanically coupling said material,
means to drive said vibrations, means to detect the frequency of said vibrations.

61. An apparatus as in claim 60 wherein said material is a member of the group consisting of palladium and palladium alloys.

62. An apparatus as in claim 60 wherein said second material is a member of the group consisting of deuterium or deuterons.

63. An apparatus as in claim 60 wherein said means to load said second material in the material is electrochemical.
